(19) United States
(12) Patent Application Publication
(10) Pub. No.: US 2007/0281528 A1
(43) Pub. Date: Dec. 6, 2007

(54) Pressing device

(75) Inventors: Martin Bronnimann, Itringen (CH); David Gerber, Giebenach (CH); Ernst Gerber, Reingoldswil (CH); Peter Tester, Jonen (CH)

Correspondence Address: HOFFMANN & BARON, LLP, 6900 JERICHO TURNPIKE, SYOSSET, NY, 11791, US

(73) Assignee: Rego-Fix AG

(21) Appl. No.: 11/809,481

(22) Filed: Jun. 1, 2007

(30) Foreign Application Priority Data
Jun. 2, 2006 (CH) 00896/06

(51) Int. Cl. H01R 13/15

(52) U.S. Cl. 439/264

(57) ABSTRACT

Pressing device for the relative axial movement of two parts, which are arranged coaxially with respect to one another and are moveable relative to one another only by means of a high pressing power, such as for example collet chucks or sleeves, into corresponding bores of tool or collet chuck holders. The device has an outer housing which coaxially surrounds the parts which are to be pressed and which can be swung open along an axial plane. Half-inserts can be inserted into said outer housing, which half-inserts comprise in each case two fixed plates with engagement edges for the engagement on one of the parts which are to be pressed, and an axially moveable pressure plate with an engagement edge for the engagement on the second part which is to be pressed.

### CROSS-REFERENCE TO RELATED APPLICATION

This patent application claims priority to Switzerland Patent Application No. 00896/06, filed Jun. 2, 2006, which is hereby incorporated by reference herein.

### FIELD OF THE INVENTION

The present invention relates to a pressing device for the relative axial movement of two parts, which are arranged coaxially with respect to one another and are moveable relative to one another only by means of a high pressing power, having a housing which coaxially surrounds the parts which are to be pressed and which, in the closed state comprises, at least one coaxial annular engagement edge for the engagement on one of the two parts which are to be pressed, a pressure plate which is axially moveable in the interior of the housing with a coaxial annular engagement edge for the engagement on the second part which is to be pressed, and a plurality of pressure cylinders which are arranged annularly at uniform angular intervals between the housing and the pressure plate.

### BACKGROUND OF THE INVENTION

Pressing processes of said type are for example used in the pressing of tube ends or shaft connections. High pressing powers are required because the friction of a close fit must be overcome and, in many cases, an additional deformation of material must be brought about. A typical example is the pressing-in and pressing-out of collet chucks or sleeves into and out of corresponding tool or collet chuck holders in machine tools.

For certain embodiments of tool receptacles, in particular those with little or no conicity of the collet chuck and holding cone, such as are preferred for machines with very high rotational speeds, the collet chucks or sleeves with the inserted tool shank cannot be directly inserted into the receptacle of the collet chuck retainer and fixed with a clamping nut, or inversely be extracted after the release of the clamping nut, but must be pressed in and out again with a high pressure. There are various solutions for said pressing-in and pressing-out processes, though said solutions are associated with disadvantages.

A pressing device which meets said requirements is described in CH-A-0862/03. Said known device is however only suitable for in each case only one tool size, that is to say several devices are required for different tool sizes. A further problem in the known device is that the required pressing power cannot be generated directly.

### SUMMARY OF THE INVENTION

The invention is based on the object of creating a pressing device which can accommodate different tool or workpiece sizes and can provide a pressing-in or pressing-out action with adapted pressures in each case.

According to the invention, said object is achieved by means of a pressing device of the type specified in the introduction which is distinguished by an outer housing and an insert, which can be inserted into said housing, composed of at least partially separable shells which comprise in each case two fixed plates with engagement edges for the engagement on one of the parts which are to be pressed, and an axially moveable pressure plate with an engagement edge for the engagement on the second part which is to be pressed.

### BRIEF DESCRIPTION OF THE DRAWINGS

A pressing-in and pressing-out device for flat-cone collet chucks as a preferred embodiment of the invention is described below on the basis of the appended drawings, in which:

FIG. 1 is a perspective illustration of a pressing device in the open state,

FIG. 2 is a corresponding illustration of the outer housing of a pressing device without an insert inserted therein,

FIG. 3 is a corresponding illustration of the outer housing of a pressing device without an insert inserted therein, with an illustration of the arrangement of pressure cylinders,

FIG. 4 is a perspective illustration of a preferred embodiment of an insert, partially in section,

FIG. 5 shows the embodiment shown in FIG. 4 from another direction and sectioned differently,

FIG. 6 shows the embodiment shown in FIG. 4, for high pressing power,

FIG. 7 shows the embodiment shown in FIG. 4, for low pressing power,

FIG. 8 shows another preferred embodiment of an insert,

FIG. 9 shows the shows the embodiment shown in FIG. 8, for low pressing power,

FIG. 10 shows a further preferred embodiment of an insert,

FIG. 11 shows a plan view of the arrangement as per FIG. 10,

FIG. 12 shows a plan view of the arrangement as per FIG. 4,

FIG. 13 shows a plan view of an alternative embodiment,

FIG. 14 shows a plan view of the pressing device with the hydraulic supply in section,

FIG. 15 shows a perspective view of the hinge of the outer housing,

FIG. 16 shows the hinge shown in FIG. 15 partially sectioned,

FIG. 17 shows a supply line diagram to the pressure cylinders, and

FIGS. 18, 19 show further possibilities for pressing power matching.

### DETAILED DESCRIPTION OF THE INVENTION

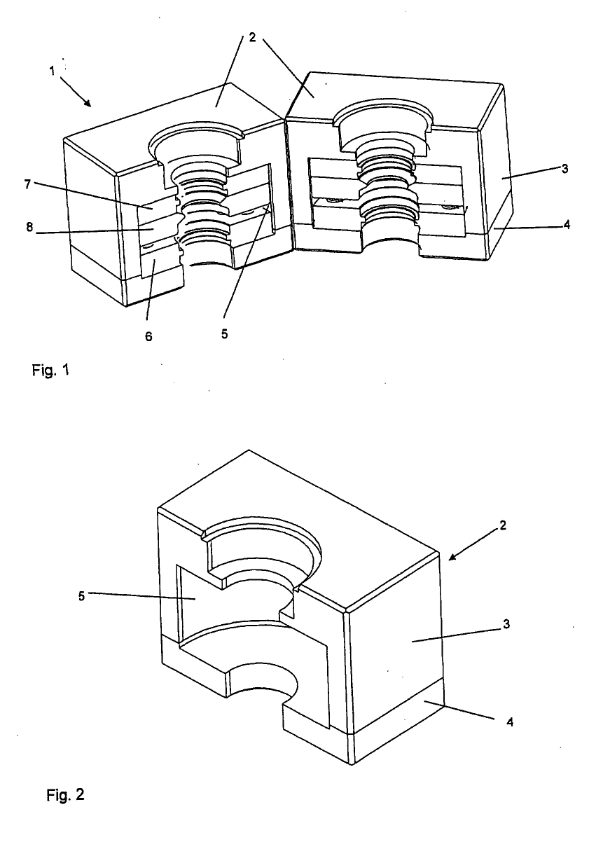

FIG. 1 shows the main parts of a pressing device according to the invention, with details such as the hinge, closure, hydraulic lines etc. being omitted from this illustration for clarity. An outer housing 1 is composed of two half-shells 2 which are rotatable relative to one another about a connecting axis and which are in each case composed of an upper part 3 and a base part 4 which is rigidly connected to said upper part 3. Each half-shell has a recess 5 into which are inserted a lower fixed plate 6, an upper fixed plate 7 and a pressure plate 8 which is moveable between the two fixed plates. The two inserts into the half-shells together form an exchangable jaw arrangement which completely encompasses inserted tool or workpiece parts when the two half-shells of the housing are closed. In the following description, the inserts in the half-shells are therefore referred to as half-inserts.

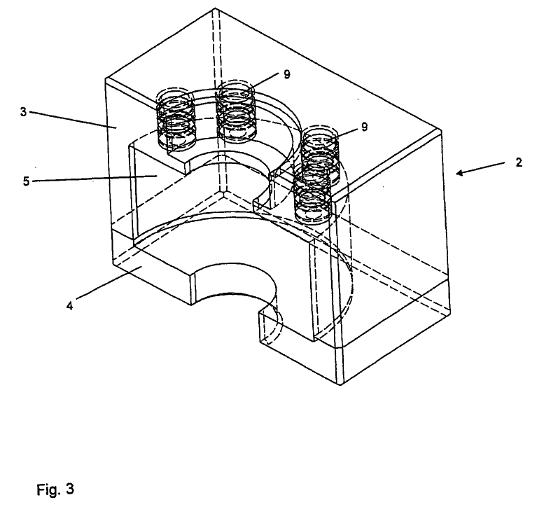

It can be seen from the illustration, shown in FIG. 2, of a half-shell 2 of the outer housing without an insert that the recess 5 has a semi-cylindrical shape. FIG. 3 is an illustration of a half-shell 2 of the outer housing in which four pressure cylinders 9, which are arranged in the body of the half-shell above the recess, can also be seen.

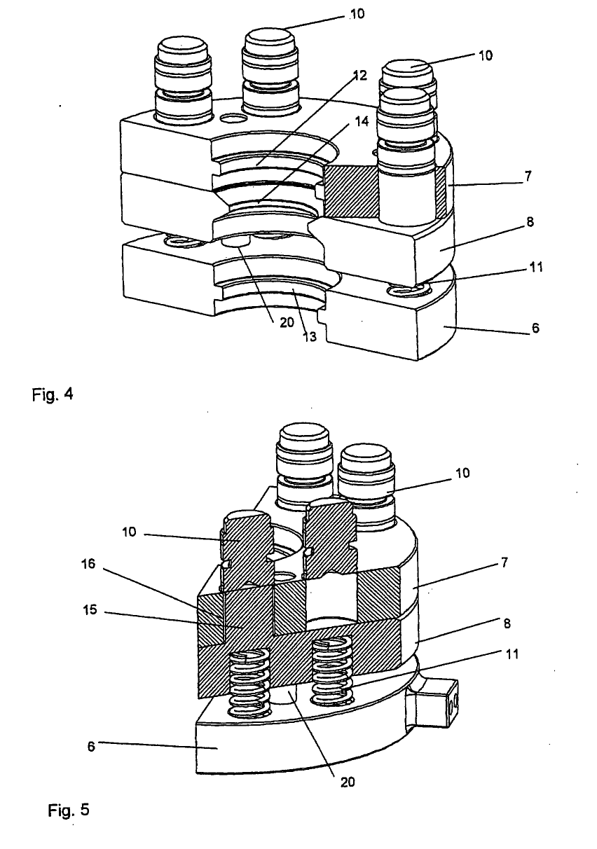

The following illustrations of FIGS. 4-10 show in each case one insert half and the pistons 10 of the pressure cylinders 9 which are arranged at the top of the outer housing. Each insert half is composed, as mentioned, of two fixed plates 6, 7 and a pressure plate 8 which can be moved between said fixed plates 6, 7 by the pressure piston 10. The pressure plate 8 is pressed against the upper fixed plate 7 by return springs 11 between the lower fixed plate 6 and the pressure plate 8 when the pressure cylinders are not acted on with pressure by the hydraulics. In this initial position or rest position, the pressure pistons are situated in their uppermost position in which they are flush with the upper side of the upper fixed plate 7 or with the upper wall of the recess 5. In this state, the insert halves can be removed from the recess.

The two fixed plates are connected to one another by means of guide pegs 20, by means of which the moveable pressure plate is guided. The insert halves thereby form a unit which can be inserted into and removed from the housing recess as a whole.

As shown in FIG. 4, the fixed upper plate 7 has an engagement edge 12 which, in order to press a collet chuck out of a retainer, engages into a corresponding groove or a shoulder of the collet chuck retainer. The lower fixed plate 6 has a corresponding engagement edge 13 for engaging into the collet chuck holder for the pressing-in process. The two engagement edges of the fixed plates are approximately rectangular in shape in cross section, that is to say their flanks lie in planes which are perpendicular to the device axis. The moveable pressure plate 8 has an engagement edge 14 for engaging into a corresponding groove of a collet chuck. On account of the corresponding engagement faces of the collet chucks, said engagement edge 14 has conical flanks, in contrast to those of the fixed plates.

As shown in FIG. 5, the pressure plate 8 has pins 15 which are integrally formed thereon in a unipartite fashion and which extend through corresponding bores 16 of the upper fixed plate 7 up to the pressure piston. Depending on the pressure which is to be exerted on the pressure plate, it is also possible for pins to be omitted from individual bores in the upper fixed plate 7, as is the case in the bore shown adjacent to the right.

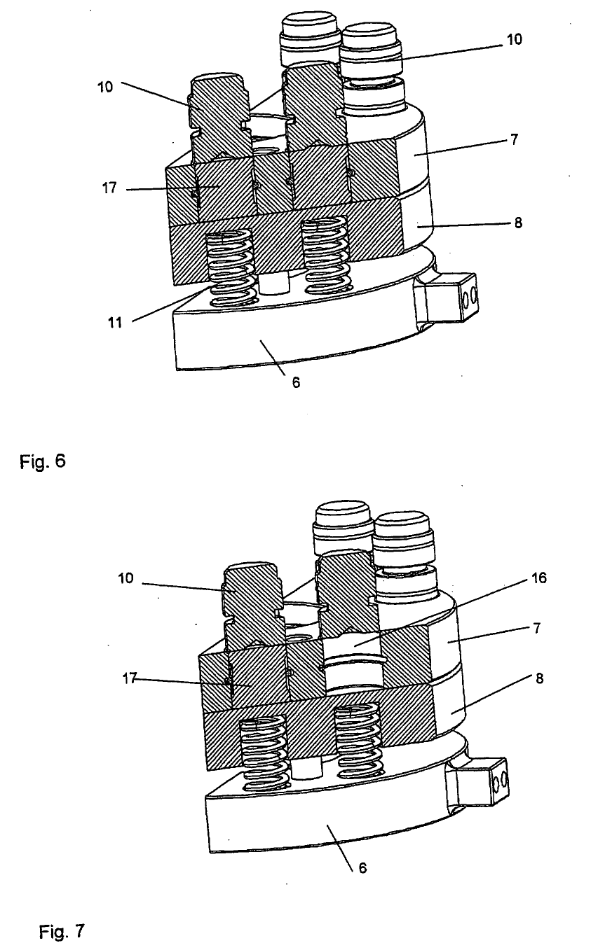

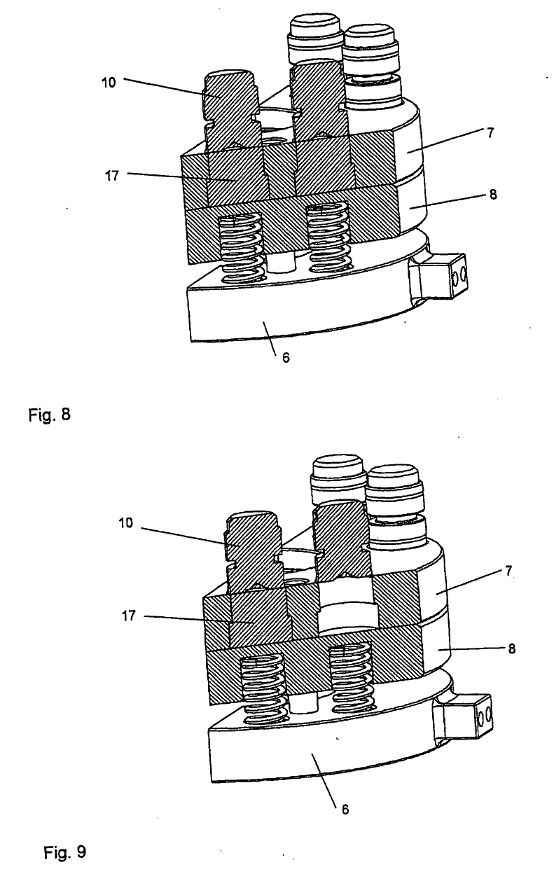

Instead of the pins 15 integrally formed in a unipartite fashion on the pressure plate, it is possible, as shown in FIGS. 6 and 7, for screwed-in pins 17 or, as in FIGS. 8-10, for pins 17 which are provided with a shoulder to be inserted into the bores of the upper plate. FIGS. 6 and 8 show pins inserted into in each case both of the bores which are visible in section, and therefore the arrangement for a higher pressure transmission to the pressure plate. In contrast, FIGS. 7 and 9 show a pin in only in each case one of two bores, and therefore an arrangement for transmitting low pressure to the pressure plate.

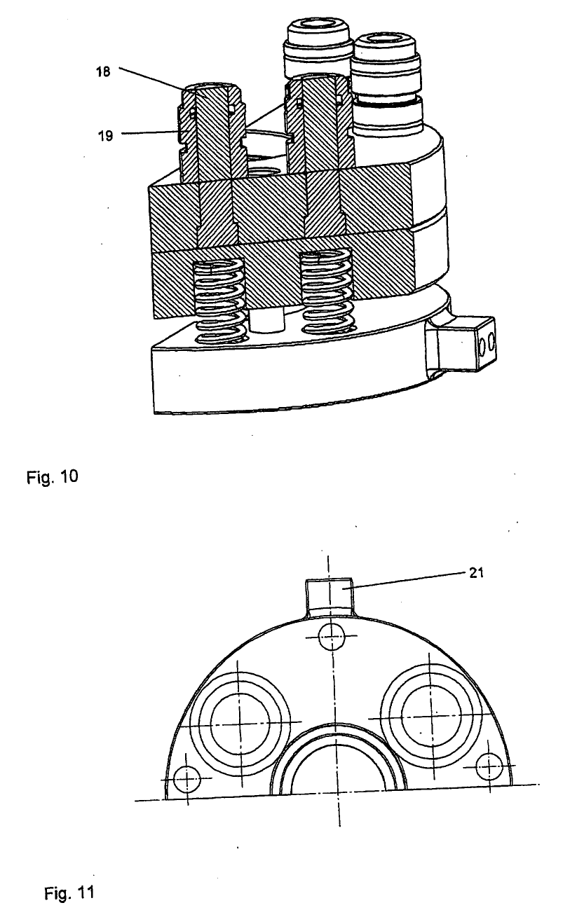

FIG. 10 shows a further variant of how the pressure transmission can take place differently according to demand. The pressure pistons are composed of an inner piston 18 and an outer piston 19 which coaxially surrounds said inner piston 18 in the manner of a telescopic arrangement. Depending on whether the pin leading to the pressure plate corresponds to the diameter of the inner or of the outer piston, either the entire or only a part of the pressure built up in the cylinder is transmitted to the pressure plate. The piston can also be divided into a plurality of coaxial pistons instead of two, in order to further sub-divide the pressure transmission.

With the coaxial piston described above and shown in FIG. 10, it is possible to arrange only two pressure cylinders per half-shell, as shown in the plan view of FIG. 11. As likewise shown in FIG. 11, the two pressure cylinders are not distributed uniformly over the semicircle, that is to say at an angle of 60°, but are displaced closed to the parting plane between the two device halves. This reduces the tipping action during pressing.

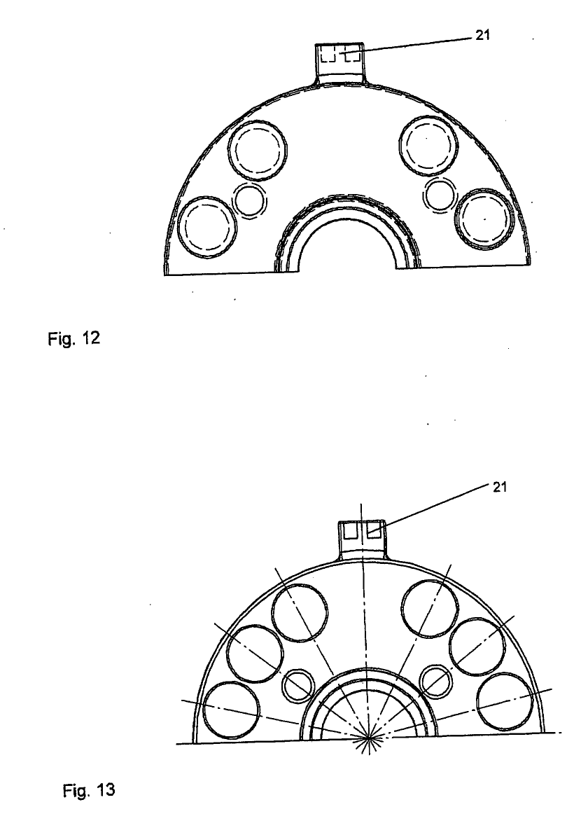

FIGS. 12 and 13 likewise show the arrangement of the pressure cylinders in a non-uniform arrangement. The four displaced pins of one insert half of the embodiment illustrated in FIG. 8 are, as shown in FIG. 12, displaced toward the parting plane. FIG. 13 shows an embodiment with six pins 16 per insert half, which pins are likewise displaced toward the parting plane in order to reduce the tipping action.

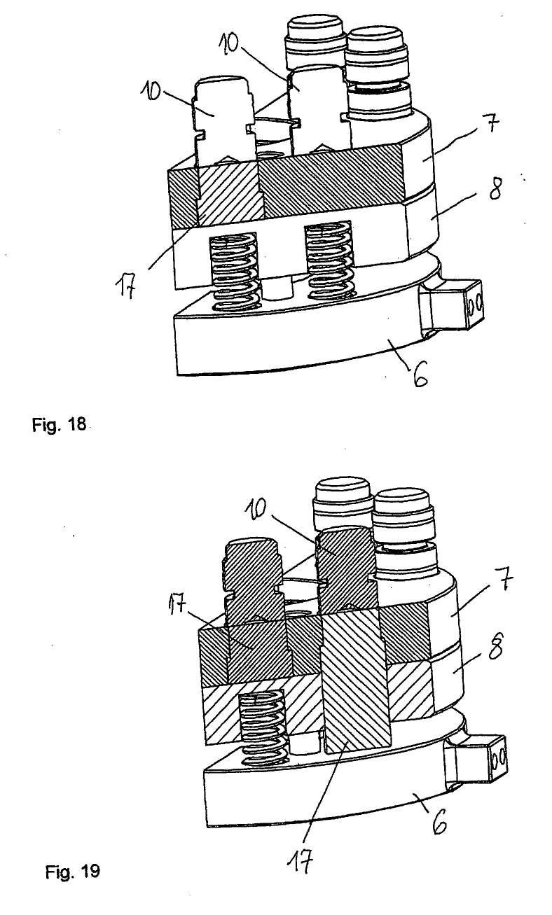

The described arrangements result, as partly explained already, in different possibilities for varying the pressing power. It is possible for one or more pins to be omitted and for the corresponding piston to press into a space. It is alternatively possible, as shown in FIG. 18, for corresponding bores to be omitted in the upper fixed plate. In this way, the corresponding pistons press against the fixed plate instead of against the pressure plate. It is alternatively possible, as shown in FIG. 19, for bores to also be provided in the pressure plate, so that the pistons press against the lower fixed plate instead of against the pressure plate.

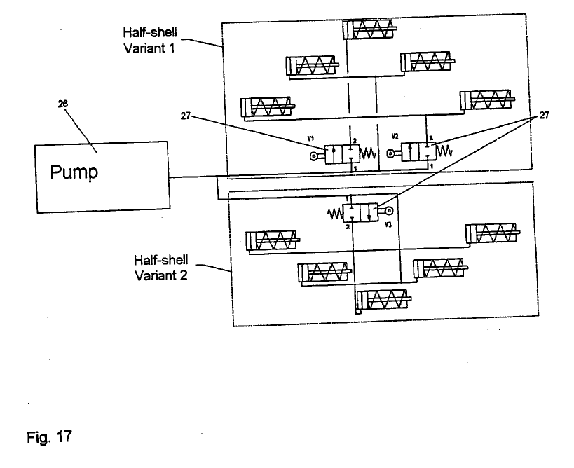

Another possibility is to close control valves in the hydraulic supply lines, and thereby to deactivate individual pressure cylinders, by means of actuating pegs 21 when inserting the respective insert halves. FIG. 17 schematically illustrates various possibilities for the control of the pressure cylinders. The hydraulic pressure is generated by a hand-operated pump 26 and is conducted to the two half-shells of the device.

Shown in the upper half-shell is a variant in which two valves 17 are provided which are opened or closed by the actuating pegs 21 when an insert is inserted. If both valves are closed, only the two central pressure cylinders are acted on with pressure and the lowest pressure stage on the pressure plate 8 is generated. If the left-hand valve is open and the right-hand valve is closed, then the upper pressure cylinder is additionally acted on with pressure, and an increased pressure is thereby exerted on the pressure plate 8. Finally, if both valves are open, then all five pressure cylinders are active.

Shown in the lower half-shell is a variant in which only one valve 27 is provided. If said valve is closed, then only the two central pressure cylinders are acted on with pressure and a relatively low pressure is exerted on the pressure plate. If the valve is opened by the insertion of an insert, then all the pressure cylinders are active and the pressure plate is provided with a higher pressure.

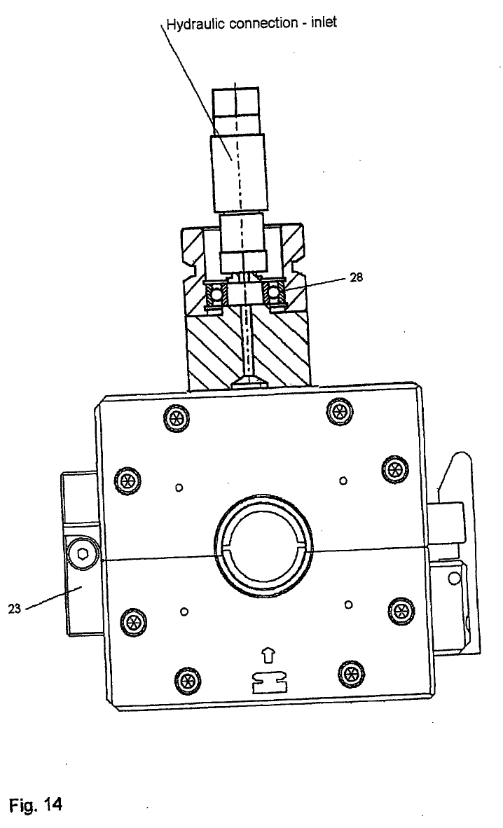

In order to avoid the risk of rupture of an oil hose, the hydraulic lines between the two half-shells of the device are integrated into the hinge 23 which connects said half-shells. FIG. 14 shows the hydraulic connection on one of the two half-shells. Said hydraulic connection serves at the same time as a rotary linkage for the rotation of the device through 180° for the exchange between the pressing-in and pressing-out processes. For this purpose, a bearing 28 is provided in the hydraulic connection.

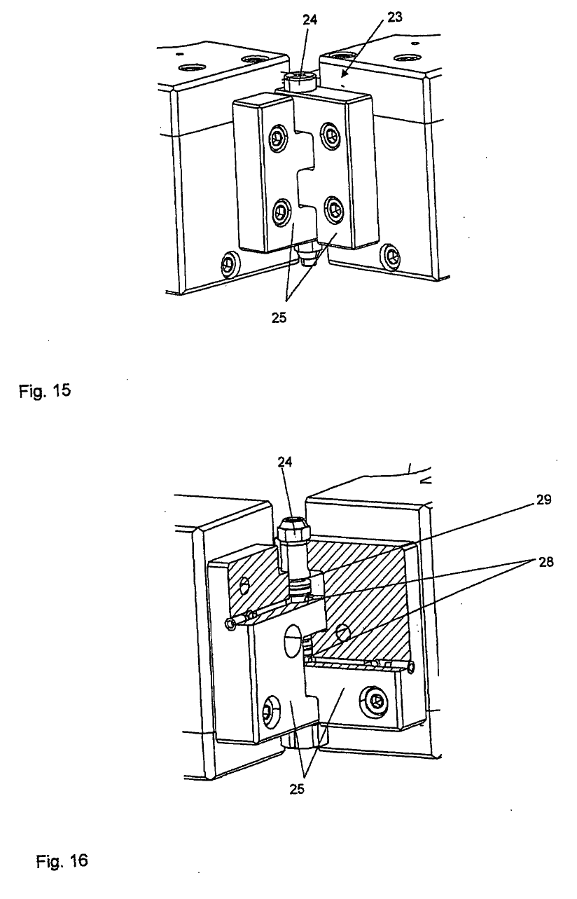

The hinge 23 is composed, as shown in FIG. 15, of two blocks 25 which engage into one another and are connected by a pin 24. FIG. 16 shows parts of the blocks in section. Provided in the blocks are bores 28 which lead outward from the pin 24 and which are closed off at their outer end by means of a screw. Said bores 28 are connected to the hydraulic supply lines to the pressure cylinders in the interior of the housing halves. The two bores in the two blocks 25 are connected to one another by means of an outwardly sealed-off recess 29 in the connecting pin 24.

While the invention has been described by reference to certain preferred embodiments, it should be understood that numerous changes could be made within the spirit and scope of the inventive concept described. Accordingly, it is intended that the invention not be limited to the disclosed embodiments, but that it have the full scope permitted by the language of the following claims.

What is claimed is:

1. Pressing device for the relative axial movement of two parts, which are arranged coaxially with respect to one another and are moveable relative to one another only by means of a high pressing power, having a housing which coaxially surrounds the parts which are to be pressed and which, in the closed state comprises, at least one coaxial annular engagement edge for the engagement on one of the two parts which are to be pressed, a pressure plate which is axially moveable in the interior of the housing with a coaxial annular engagement edge for the engagement on the second part which is to be pressed, and a plurality of annularly arranged pressure cylinders, characterized by an outer housing, which can be swung open along an axial plane, and half-inserts which can be inserted into said outer housing and which comprise in each case two fixed plates, with engagement edges for the engagement on one of the parts which are to be pressed, and an axially moveable pressure plate with an engagement edge for the engagement on the second part which is to be pressed.

2. Pressing device according to claim 1, characterized in that half-inserts of different size are provided in order to press parts of different size.

3. Pressing device according to claim 1, characterized in that the action of the pressure cylinders is selectively controlled in order to generate different pressing powers.

4. Pressing device according to claim 3, characterized in that valves are provided in order to selectively control the pressure cylinders, which valves are actuated when the half-inserts are inserted.

5. Pressing device according to claim 3, characterized in that pressure transmission elements to the pressure plates are omitted from individual inserts.

6. Pressing device according to claim 1, characterized in that the distribution of the pressure cylinders is non-uniform and offset towards the parting plane between the half-shells.
